(19) United States
(12) Patent Application Publication
(10) Pub. No.: US 2014/0186518 A1
(43) Pub. Date: Jul. 3, 2014

(54) Alignment film coating method and system for liquid crystal panel

(71) Applicants: Hsiang-yin Shih, Shenzhen (CN); Cheng-chuan Chan, Shenzhen (CN); Bing-jei Liao, Shenzhen (CN)

(72) Inventors: Hsiang-yin Shih, Shenzhen (CN); Cheng-chuan Chan, Shenzhen (CN); Bing-jei Liao, Shenzhen (CN)

(73) Assignee: Shenzhen China Star Optoelectronics Technology Co. Ltd., Guangdong (CN)

(21) Appl. No.: 13/264,543

(22) PCT Filed: Aug. 10, 2011
(86) PCT No.: PCT/CN11/78235

§ 371 Date: Oct. 14, 2011

(30) Foreign Application Priority Data
Jul. 28, 2011 (CN) 201110213915.7

(51) Int. Cl. G02F 1/1333; G02F 1/13

(52) U.S. Cl. CPC G02F 1/1333; G02F 1/1303
USPC 427/58; 118/696

(57) ABSTRACT

A method of coating an alignment film for a liquid crystal panel and a system of the same are disclosed. Said method comprises steps of: providing a measuring instrument, a computer, and an ink jet printing machine; obtaining a pixel height difference of a pixel unit in the liquid crystal panel and the height of said pixel unit by using the measuring instrument; generating a coating amount by using the computer to calculate according to a predetermined equation and based on the pixel height difference of the pixel unit and the height of said pixel unit; and coating the alignment film on the pixel unit according to the coating amount calculated by the computer, by using the ink jet printing machine that is connected to the computer. The present invention can solve the problem of mura caused by unequal thickness of an alignment film.

### TECHNICAL FIELD OF THE INVENTION

The present invention relates to a liquid crystal displaying technique, and more particularly, to an alignment film coating method and system for a liquid crystal panel.

### BACKGROUND OF THE INVENTION

As liquid crystal displaying technology is improved constantly, the performance requirements for each element in a liquid crystal display are higher and higher.

The alignment film coating technique used in a high-generation liquid crystal panel generally adopts an approach of ink jetting for dropping an alignment material with high speed and high density to spread on the surface of a thin film transistor (TFT) substrate or a color filter (CF) substrate by using an ink jet printing machine. The alignment material is in a form of droplet and the droplet becomes flat due to the diffusion of the molecules in the droplet and surface tension formed thereon, and thus an alignment film is formed.

In the operating processes, the coating effect of the ink jet printing machine will be influenced by a via hole through an indium thin oxide (ITO) layer and a pixel height difference (e.g., RGB height difference) of a pixel unit on the CF substrate such that the droplets of the same size may result in different formation qualities of the alignment film. Particularly, if the droplet of the alignment material falls into the via hole of the TFT substrate, the alignment film will be formed with unequal thickness, and thereby causing a problem of mura.

Referring to FIGS. 1A to 1B, FIG. 1A is a schematic diagram showing a liquid crystal panel before proceeding a coating and FIG. 1B is a schematic diagram showing a liquid crystal panel after proceeding a coating. When the ink jet printing machine proceeds a coating, the coating direction B2 is perpendicular to an arrangement direction B1 of the respective pixels in the pixel unit. Some of nozzles of the ink jet printing machine are located corresponding to the positions of gaps between the respective pixels of the pixel unit. Referring to FIG. 1B, all the droplets from the nozzles 11 shown in FIG. 1A fall into the gaps between the respective pixels of the pixel unit. Since there are height differences existed between the respective pixels of the pixel unit, the fallen droplets in the gaps can not diffuse across the surfaces of the respective pixels evenly. Therefore, the thickness of the alignment film at the positions located between pixels or pixel units is unequal, and thus causing the problem of mura.

To solve the mura problem caused by unequal thickness of the alignment film, conventional skills usually adopt an approach of increasing the size of the droplet of the alignment material or slowing down the moving speed of the nozzles for avoiding forming the unequal thickness of the alignment film. However, the viscosity of the droplet of the alignment material is still a factor to cause the unequal diffusion of the droplet, and thus the alignment film may still be formed with unequal thickness. Moreover, once the alignment film is formed with unequal thickness, it needs to restart a coating procedure and thereby inevitably resulting in a low yield rate for producing the liquid crystal displays.

Above all, how to solve the problem of mura caused by unequal thickness of an alignment film and the problem of low product yield rate in the conventional skills is an important aspect in the liquid crystal displaying technical filed.

### SUMMARY OF THE INVENTION

The objective of the present invention is to provide an alignment film coating method and system for a liquid crystal panel, for solving the problem of mura caused by unequal thickness of an alignment film and solving the problem of low product yield rate resulted from the mura phenomenon.

To solve the above problems, the present invention provides a method of coating an alignment film for a liquid crystal panel, said method comprising steps of:

providing a measuring instrument, a computer, and an ink jet printing machine; obtaining a pixel height difference of a pixel unit in the liquid crystal panel and the height of said pixel unit by using the measuring instrument; generating a coating amount by using the computer to calculate according to a predetermined equation and based on the pixel height difference of the pixel unit and the height of said pixel unit that are obtained by the measuring instrument; and coating the alignment film on the pixel unit according to the coating amount calculated by the computer, by using the ink jet printing machine that is connected to the computer; wherein the predetermined equation is V=A*(Hps+⅓(2Hb−Hr−Hg)), where V is the coating amount, Hps is the height of the pixel unit, and 2Hb−Hr−Hg is the pixel height difference of the pixel unit; wherein an arrangement direction of nozzles of the ink jet printing machine is parallel to long edges of the respective pixels in the pixel unit.

In the alignment film coating method of the present invention, before the step of generating a coating amount by using the computer to calculate according to a predetermined equation and based on the pixel height difference of the pixel unit and the height of said pixel unit that are obtained by the measuring instrument, said method further comprises steps of: storing the predetermined equation in the computer; and storing the pixel height difference of the pixel units and the height of said pixel unit after the measuring instrument obtains the pixel height difference of the pixel unit and the height of said pixel unit.

In the alignment film coating method of the present invention, the measuring instrument is an interferometer.

In another aspect, the present invention provides a method of coating an alignment film for a liquid crystal panel, said method comprising steps of: providing a measuring instrument, a computer, and an ink jet printing machine; obtaining a pixel height difference of a pixel unit in the liquid crystal panel and the height of said pixel unit by using the measuring instrument; generating a coating amount by using the computer to calculate according to a predetermined equation and based on the pixel height difference of the pixel unit and the height of said pixel unit that are obtained by the measuring instrument; and coating the alignment film on the pixel unit according to the coating amount calculated by the computer, by using the ink jet printing machine that is connected to the computer.

In the alignment film coating method of the present invention, the predetermined equation is V=A*(Hps+⅓(2Hb−Hr−Hg)), where V is the coating amount, Hps is the height of the pixel unit, and 2Hb−Hr−Hg is the pixel height difference of the pixel unit.

In the alignment film coating method of the present invention, an arrangement direction of nozzles of the ink jet printing machine is parallel to long edges of the respective pixels in the pixel unit.

In the alignment film coating method of the present invention, before the step of generating a coating amount by using the computer to calculate according to a predetermined equation and based on the pixel height difference of the pixel unit and the height of said pixel unit that are obtained by the measuring instrument, said method further comprises steps of: storing the predetermined equation in the computer; and storing the pixel height difference of the pixel unit and the height of said pixel unit that are obtained by the measuring instrument.

In the alignment film coating method of the present invention, the measuring instrument is an interferometer.

In still another aspect, the present invention provides a system for coating an arrangement film for a liquid crystal panel, said system comprising: a measuring instrument for obtaining a pixel height difference of a pixel unit in the liquid crystal panel and the height of said pixel unit; a computer for generating a coating amount by calculating according to a predetermined equation and based on the pixel height difference of the pixel unit and the height of said pixel unit that are obtained by the measuring instrument; and an ink jet printing machine connected to the computer, for coating the alignment film on the pixel unit according to the coating amount calculated by the computer.

In the alignment film coating system of the present invention, the predetermined equation is V=A*(Hps+⅓(2Hb−Hr−Hg)), where V is the coating amount, Hps is the height of the pixel unit, and 2Hb−Hr−Hg is the pixel height difference of the pixel unit.

In the alignment film coating system of the present invention, an arrangement direction of nozzles of the ink jet printing machine is parallel to long edges of the respective pixels in the pixel unit.

In the alignment film coating system of the present invention, the computer is further used for storing the predetermined equation and storing the pixel height difference of the pixel unit and the height of said pixel unit that are obtained by the measuring instrument.

In the alignment film coating system of the present invention, the measuring instrument is an interferometer.

Compared to the conventional skills, the present invention can solve the problem of mura caused by unequal thickness of an alignment film, and thus the present invention can promote a product yield rate.

### BRIEF DESCRIPTION OF THE DRAWINGS

The present invention will be described in details in conjunction with the appending drawings.

FIGS. 1A to 1B are schematic diagrams showing a coating effect created by using an ink jet printing machine to coat a film on a liquid crystal panel in conventional skills.

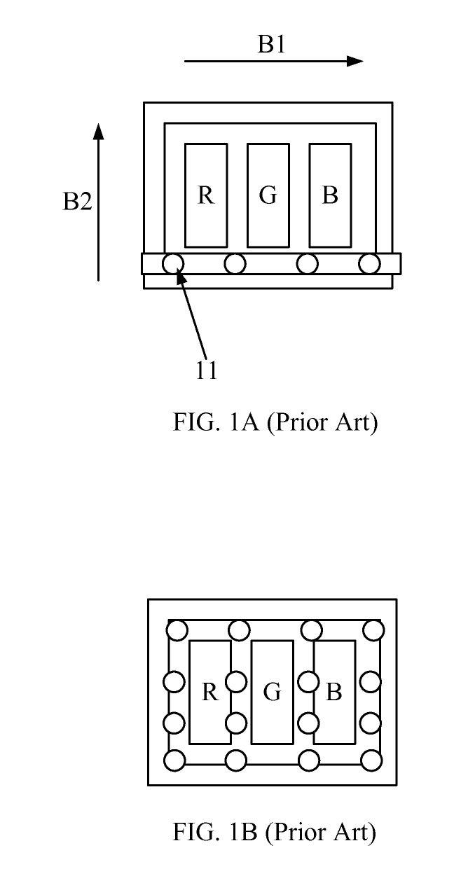

FIG. 2 is a flow chart of an arrangement film coating method for a liquid crystal panel in the present invention.

FIGS. 3A to 3B are schematic diagrams showing a liquid droplet for forming an arrangement film in the present invention.

FIGS. 4A to 4B are schematic structural diagrams showing an arrangement of pixels in a pixel unit in the present invention.

FIG. 5 is a schematic diagram showing the volume of a pixel unit in the present invention.

FIGS. 6A to 6B are schematic diagrams showing a coating effect created by using an ink jet printing machine to coat a film on a liquid crystal panel in the present invention.

FIG. 7 is a schematic structural diagram showing an arrangement film coating system for a liquid crystal display in the present invention.

### DETAILED DESCRIPTION OF THE INVENTION

The following descriptions for the respective embodiments are specific embodiments capable of being implemented for illustrations of the present invention with referring to appended figures.

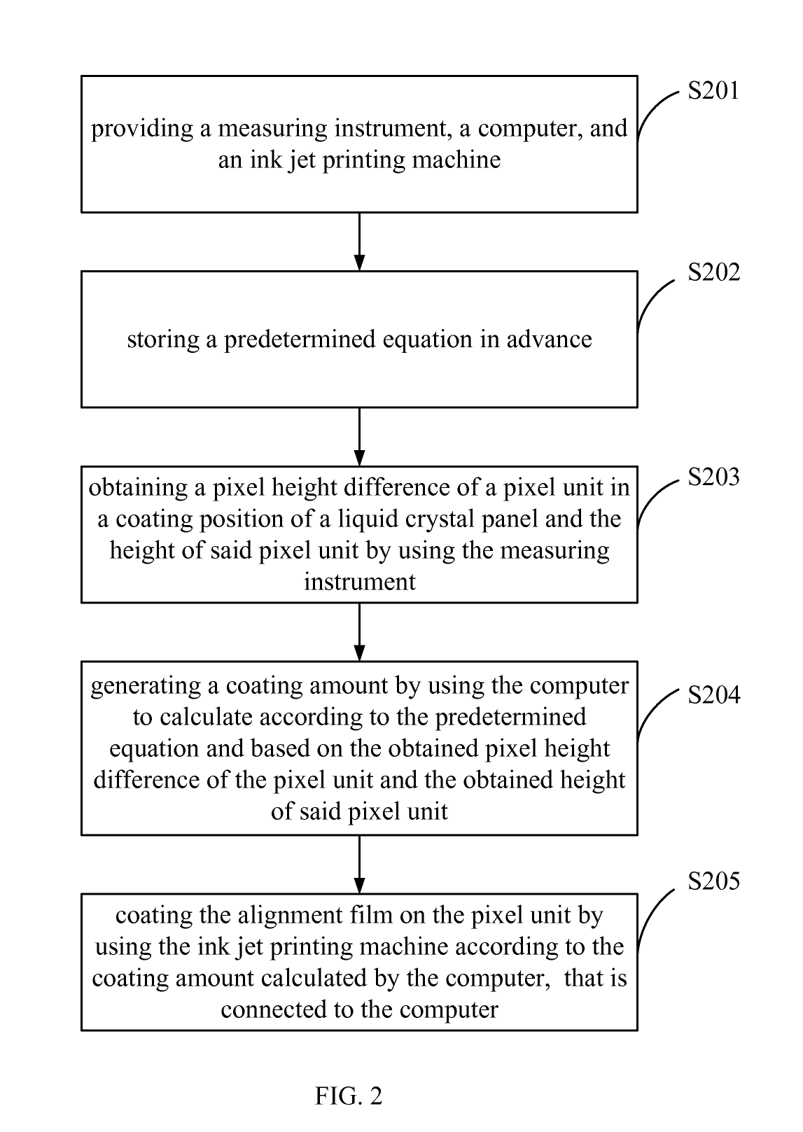

Referring to FIG. 2, FIG. 2 is a flow chart of an arrangement film coating method for a liquid crystal panel in the present invention.

In Step S201, a measuring instrument, a computer and an ink jet printing machine are provided herein.

In Step S202, a predetermined equation is stored in advance.

In the present invention, the predetermined equation is V=A*(Hps+⅓(2Hb−Hr−Hg)), where V is a coating amount, Hps is the height of a pixel unit, 2Hb−Hr−Hg is a pixel height difference of the pixel unit, Hb is the height of pixel B, Hr is the height of pixel R, and Hg is the height of pixel G. In the present invention, the predetermined equation is stored in the computer.

The derivation of the predetermined equation of the present invention is described detailedly as follows.

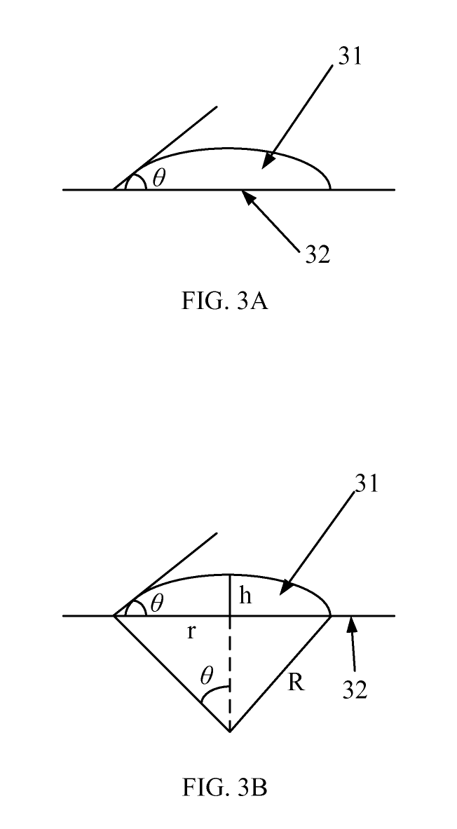

Referring to FIGS. 3A to 3B, a liquid droplet 31 for forming the alignment film would have different surface tension when applying different kinds of materials. At the time the liquid droplet 31 touches a substrate 32, the contact angel θ will gradually become flat, and eventually brining into equilibrium. Since the liquid droplet 31 does not infiltrate into the substrate 32, the volume of the liquid droplet 31 will not change. Also, the contact angle θ is not varied in the end.

The initial volume V₀ of the liquid droplet 31 satisfies the following equation.

$${V}_{0} = \frac{2 π {R}^{3}}{3} ( 1 - cos θ ) - \frac{π {r}^{2} ( R - h )}{3} \qquad Equation ( 1 )$$

Referring to FIG. 3B, the following equations are obtained by utilizing trigonometric functions.

cos θ=(R−h)/R Equation (2)

r=sin θ×R Equation (3)

A theoretic radius of the flat liquid droplet 31 can be obtained by solving the simultaneous Equations (1), (2), and (3), and is represented as:

$$r = \sqrt[3]{\frac{3 {V}_{0} {sin}^{3} θ}{π ( 2 - 2 cos θ - {sin}^{2} θ \times cos θ ) }}$$

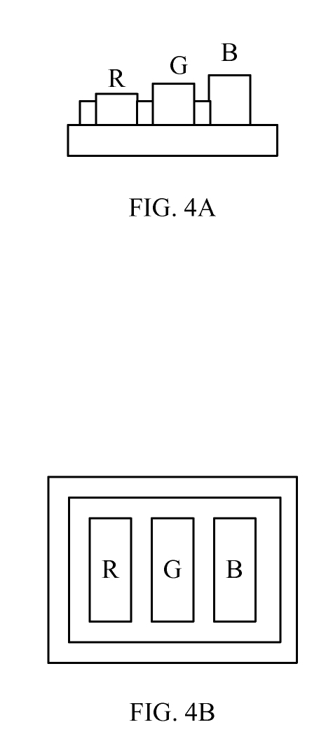

Referring to FIGS. 4A and 4B, FIGS. 4A and 4B show a structure arrangement of pixels in a pixel unit. FIG. 4A is a sectional view of the pixel unit. FIG. 4B is a top view of the pixel unit.

The pixel unit has a pixel R, a pixel G, and a pixel B that are formed with three primary colors. The respective pixels have different height differences existed therebetween. The aforesaid height differences will affect the diffusion of the molecules in the liquid droplet.

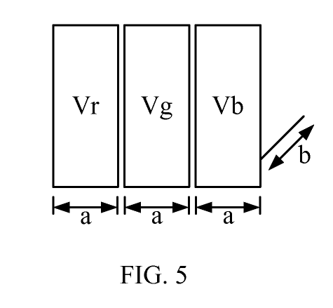

Referring to FIG. 5, FIG. 5 is a top view of the pixel unit. According to the conservation of volume, the relation between the pixel height difference of the pixel unit and the volume V of space corresponding to the pixel unit in the liquid crystal panel can be derived.

V=Vr+Vg+Vb=A*Hps, A=3a*b, where Vr, Vg, and Vb are the space volumes respectively corresponding to the pixel R, the pixel G, and the pixel B,;

V=⅓*A*Hr+⅓*A*Hg+⅓*A*Hb;

V=⅓*A*(Hr+Hg+Hb);

V=⅓*A*(3Hps+(Hb−Hr)+(Hb=Hg)+(Hb−Hb));

V=A*(Hps+⅓(2Hb−Hr−Hg)).

In the above equations, the space volume V of the liquid crystal panel is indeed the coating amount. The coating amount, the height of the pixel unit, and the pixel height difference of the pixel unit are related in mathematics.

Please refer to FIG. 2 again. In Step S203, the pixel height difference 2Hb−Hr−Hg of the pixel unit located at a coating position in the liquid crystal panel and the height Hps of said pixel unit are obtained by the measuring instrument.

In the present embodiment, it can use an apparatus such as Zygo interferometer to measure the pixel height difference of the pixel unit and the height of said pixel unit for each color filter. Of course, it also can utilize other apparatuses which will not be detailed herein.

In Step S204, the computer generates the coating amount V by calculating according to the predetermined equation and based on the obtained pixel height difference of the pixel unit and the obtained height of said pixel unit.

In the implementation, the computer also can be used for storing the pixel height difference of the pixel unit on the color filter and the height of said pixel unit that are obtained by the measuring instrument, and this will not be detailed herein.

In Step S205, the ink jet printing machine connected to the computer proceeds the coating of the alignment film on the pixel unit according to the coating amount calculated by the computer.

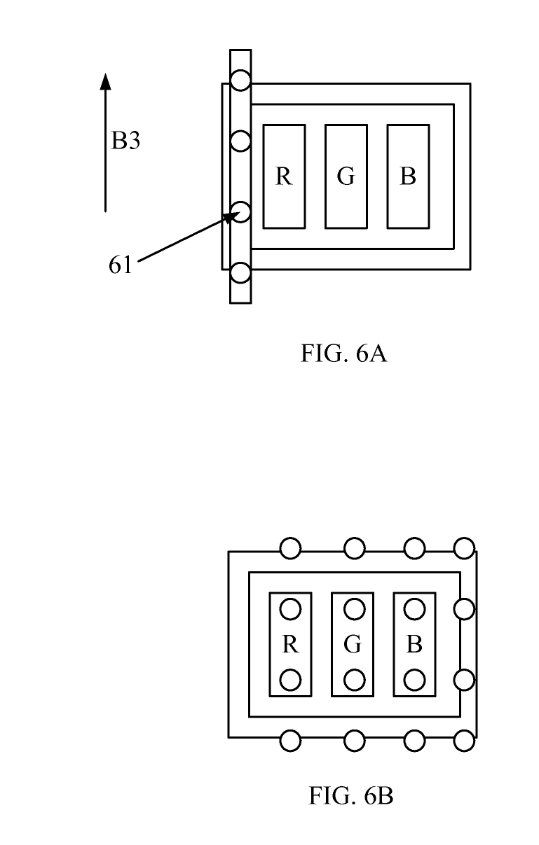

Referring to FIGS. 6A to 6B, FIG. 6A is a schematic diagram showing a liquid crystal panel before proceeding a coating. In the present embodiment, an arrangement direction B3 of nozzles 61 of the ink jet printing machine is parallel to long edges of the respective pixels in the pixel unit, and in such a manner that it can effectively avoid the liquid droplets from the nozzles 61 falling into the gaps between the respective pixels in the pixel unit. Referring to FIG. 6B, it is apparent that the liquid droplets are equally spread on the pixels, and thereby ensuring that an arrangement film of uniform thickness is formed.

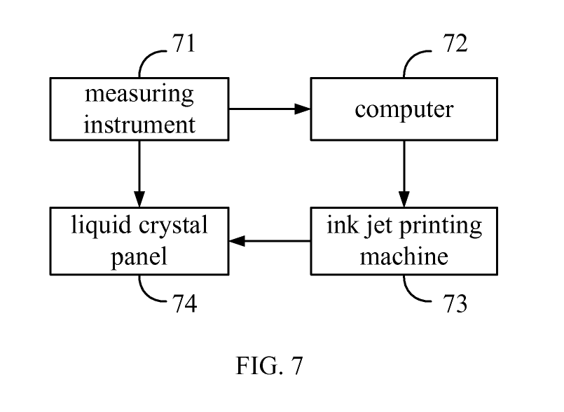

Referring to FIG. 7, the present invention further provides an arrangement film coating system for a liquid crystal display.

As shown in FIG. 7, the arrangement film coating system for a color filter of the liquid crystal display comprises a measuring instrument 71, a computer 72, and an ink jet printing machine 73, and further comprises a liquid crystal panel 74 that is to be coated with the arrangement film. The liquid crystal panel 74 has pixel units (not shown) disposed thereon.

The measuring instrument 71 obtains a pixel height difference of a pixel unit on the color filter and the height of said pixel unit.

Preferably, the measuring instrument 71 is an interferometer such as Zygo interferometer. Of course, it also can utilize other apparatuses which will not be detailed herein.

The computer 72 generates a coating amount by calculating according to a predetermined equation and based on the obtained pixel height difference of the pixel unit and the obtained height of said pixel unit.

In the implementation, the computer 72 stores the predetermined equation in advance, and stores the pixel height difference of the pixel unit and the height of said pixel unit after the measuring instrument 71 obtains the pixel height difference of the pixel unit in the liquid crystal panel 74 and the height of said pixel unit.

The ink jet printing machine 73 is connected to the computer 72. The ink jet printing machine 73 coats the alignment film on the pixel unit of the liquid crystal panel 74 according to the coating amount calculated by the computer 72.

The predetermined equation is V=A*(Hps+⅓(2Hb−Hr−Hg)), where V is the coating amount, Hps is the height of the pixel unit, and 2Hb−Hr−Hg is the pixel height difference of the pixel unit. Concerning this part, please refer to the above descriptions and not repeated again herein.

In the implementation, an arrangement direction of nozzles of the ink jet printing machine is parallel to long edges of the respective pixels in the pixel unit. Concerning this part, please refer to FIGS. 6A to 6B and not repeated again herein.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method of coating an alignment film for a liquid crystal panel, characterized in that said method comprises steps of:
providing a measuring instrument, a computer, and an ink jet printing machine;
obtaining a pixel height difference of a pixel unit in the liquid crystal panel and the height of said pixel unit by using the measuring instrument;
generating a coating amount by using the computer to calculate according to a predetermined equation and based on the pixel height difference of the pixel unit and the height of said pixel unit that are obtained by the measuring instrument; and
coating the alignment film on the pixel unit according to the coating amount calculated by the computer, by using the ink jet printing machine that is connected to the computer;
wherein the predetermined equation is V=A*(Hps+⅓(2Hb−Hr−Hg)), where V is the coating amount, Hps is the height of the pixel unit, and 2Hb−Hr−Hg is the pixel height difference of the pixel unit;
wherein an arrangement direction of nozzles of the ink jet printing machine is parallel to long edges of the respective pixels in the pixel unit.

2. The method according to claim 1, characterized in that before the step of generating a coating amount by using the computer to calculate according to a predetermined equation and based on the pixel height difference of the pixel unit and the height of said pixel unit that are obtained by the measuring instrument, said method further comprises steps of:
storing the predetermined equation in the computer; and
storing the pixel height difference of the pixel units and the height of said pixel unit after the measuring instrument obtains the pixel height difference of the pixel unit and the height of said pixel unit.

3. The method according to claim 1, characterized in that the measuring instrument is an interferometer.

4. A method of coating an alignment film for a liquid crystal panel, characterized in that said method comprises steps of:
providing a measuring instrument, a computer, and an ink jet printing machine;
obtaining a pixel height difference of a pixel unit in the liquid crystal panel and the height of said pixel unit by using the measuring instrument;
generating a coating amount by using the computer to calculate according to a predetermined equation and based on the pixel height difference of the pixel unit and the height of said pixel unit that are obtained by the measuring instrument; and
coating the alignment film on the pixel unit according to the coating amount calculated by the computer, by using the ink jet printing machine that is connected to the computer.

5. The method according to claim 4, characterized in that the predetermined equation is V=A*(Hps+⅓(2Hb−Hr−Hg)), where V is the coating amount, Hps is the height of the pixel unit, and 2Hb−Hr−Hg is the pixel height difference of the pixel unit.

6. The method according to claim 4, characterized in that an arrangement direction of nozzles of the ink jet printing machine is parallel to long edges of the respective pixels in the pixel unit.

7. The method according to claim 4, characterized in that before the step of generating a coating amount by using the computer to calculate according to a predetermined equation and based on the pixel height difference of the pixel unit and the height of said pixel unit that are obtained by the measuring instrument, said method further comprises steps of:
storing the predetermined equation in the computer; and
storing the pixel height difference of the pixel unit and the height of said pixel unit after the measuring instrument obtains the pixel height difference of the pixel unit and the height of said pixel unit.

8. The method according to claim 4, characterized in that the measuring instrument is an interferometer.

9. A system for coating an arrangement film for a liquid crystal panel, characterized in that said system comprises:
a measuring instrument for obtaining a pixel height difference of a pixel unit in the liquid crystal panel and the height of said pixel unit;
a computer for generating a coating amount by calculating according to a predetermined equation and based on the pixel height difference of the pixel unit and the height of said pixel unit that are obtained by the measuring instrument; and
an ink jet printing machine connected to the computer, for coating the alignment film on the pixel unit according to the coating amount calculated by the computer.

10. The system according to claim 9, characterized in that the predetermined equation is V=A*(Hps+⅓(2Hb−Hr−Hg)), where V is the coating amount, Hps is the height of the pixel unit, and 2Hb−Hr−Hg is the pixel height difference of the pixel unit.

11. The system according to claim 9, characterized in that an arrangement direction of nozzles of the ink jet printing machine is parallel to long edges of the respective pixels in the pixel unit.

12. The system according to claim 9, characterized in that the computer is further used for storing the predetermined equation and storing the pixel height difference of the pixel unit and the height of said pixel unit that are obtained by the measuring instrument.

13. The system according to claim 9, characterized in that the measuring instrument is an interferometer.
